(19) United States
(12) Patent Application Publication
(10) Pub. No.: US 2007/0139961 A1
(43) Pub. Date: Jun. 21, 2007

(54) Method and apparatus employing a heat sink, a flexible printed circuit conformed to at least part of the heat sink, and a light source attached to the flexible printed circuit

(76) Inventors: Chun Hean Cheah, Penang (MY); Kee Yean Ng, Penang (MY)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/316,067

(22) Filed: Dec. 19, 2005

(51) Int. Cl. F21V 7/04

(52) U.S. Cl. 362/612

(57) ABSTRACT

In one embodiment, a light source is attached to a first side of a flexible printed circuit; and the flexible printed circuit is conformed to at least part of a heat sink. A cross-section of the heat sink has surfaces facing in different directions, and conforming the flexible printed circuit to the at least part of the heat sink causes a second side of the flexible printed circuit, opposite the first side, to contact ones of the surfaces of the heat sink facing in at least two different directions. Also disclosed are various apparatus that include a heat sink, a flexible printed circuit conformed to the heat sink, and a light source attached to the flexible printed circuit.

### BACKGROUND

In a liquid crystal display (LCD), an array of liquid crystal molecules is trapped between two polarizing plates. One of the plates is horizontally polarized, and the other plate is vertically polarized. A backlight is positioned on one side of the LCD, and in response to varying electrical currents that are applied to the array of liquid crystal molecules, different amounts of the backlight's light are allowed to pass through the different pixels of the LCD, thereby producing an image.

The light produced by an LCD's backlight is typically mixed, and then directed toward an LCD, via a light guide. If the light guide is properly designed, the majority of the light produced by the backlight should be directed toward the LCD. However, it is inevitable that some of the light that a backlight produces will be reflected back toward the backlight (e.g., as a result of inefficiencies in the optical coupling between the backlight and the light guide, and for other reasons). These back-reflections of light, as well as the reletively high currents that are often necessary to drive the light emitting elements of the backlight, cause the backlight to generate a significant amount of heat. As a result, it is typically necessary to couple the backlight to a heat sink. However, while increased size, better airflow and water-cooling would all help to improve the efficiency of the heat sink, these attributes are difficult to implement in environments where space is limited (e.g., in the case of a mobile phone, personal digital assistant (PDA) or other small or hand-held electronic device).

### SUMMARY OF THE INVENTION

In one embodiment, a method comprises 1) attaching a light source to a first side of a flexible printed circuit, and 2) conforming the flexible printed circuit to at least part of a heat sink. The heat sink has a cross-section that has surfaces facing in different directions, such that, by conforming the flexible printed circuit to the at least part of the heat sink, a second side of the flexible printed circuit, opposite the first side, is caused to contact ones of the surfaces of the heat sink facing in at least two different directions.

In another embodiment, apparatus comprises a heat sink, a flexible printed circuit and a light source. The heat sink defines a channel with a cross-section that has a plurality of interior surfaces facing in different directions. The flexible printed circuit has a first side opposite a second side, and is flexed to conform to at least part of the channel defined by the heat sink, such that the second side of the flexible printed circuit contacts ones of the interior surfaces of the channel facing in at least two different directions. The light source is mounted to the first side of the flexible printed circuit, at least partly within the channel defined by the heat sink.

In yet another embodiment, apparatus comprises a heat sink, a flexible printed circuit and a light source. The cross-section of the heat sink has exterior surfaces facing in different directions. The flexible printed circuit has a first side opposite a second side, and is flexed to conform to at least part of the heat sink, such that the second side of the flexible printed circuit contacts ones of the exterior surfaces of the heat sink facing in at least two different directions. The light source is mounted to the first side of the flexible printed circuit.

Other embodiments are also disclosed.

### BRIEF DESCRIPTION OF THE DRAWINGS

Illustrative embodiments of the invention are illustrated in the drawings, in which:

FIG. 1 provides a perspective view of a first exemplary apparatus comprising a heat sink, a flexible printed circuit board and a light source;

FIG. 2 illustrates a cross-section of the apparatus shown in FIG. 1;

FIG. 3 illustrates abutment of the FIG. 1 apparatus to a light guide;

FIG. 4 illustrates an exemplary method for constructing the apparatus shown in FIGS. 1-3, or the apparatus shown in FIGS. 5, 6 & 8;

FIG. 5 provides a perspective view of a second exemplary apparatus comprising a heat sink, a flexible printed circuit board and a light source;

FIG. 6 illustrates a first exemplary cross-section of the apparatus shown in FIG. 5;

FIG. 7 illustrates a second exemplary cross-section of the apparatus shown in FIG. 5; and

FIG. 8 illustrates abutment of the FIG. 5 apparatus to a light guide.

### DETAILED DESCRIPTION

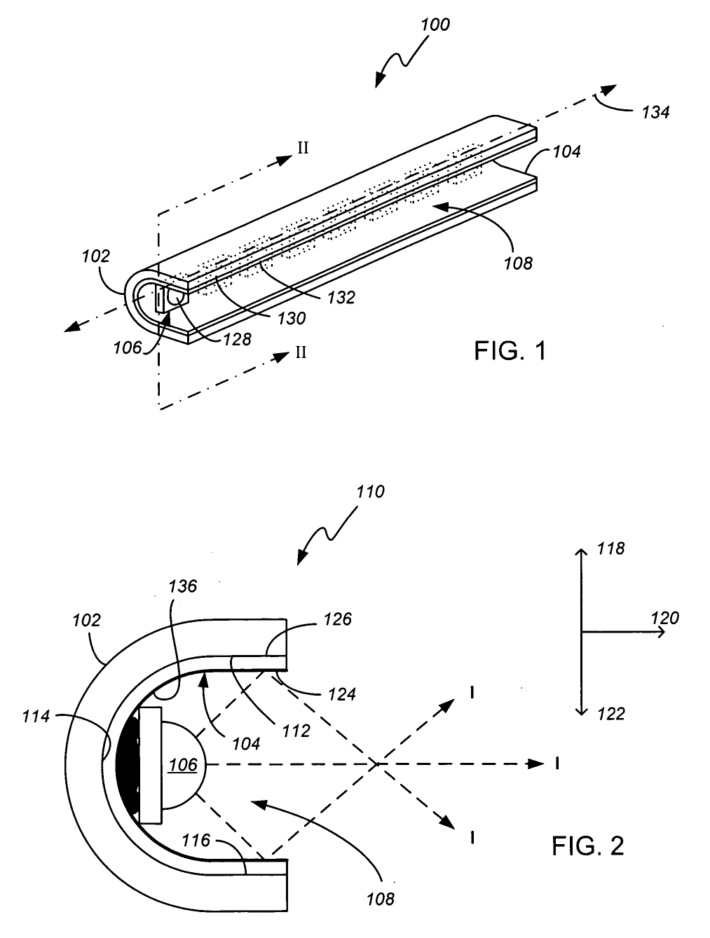

In an effort to improve heat dissipation for a backlight, and/or to cause a greater percentage of a backlight's light to be directed toward a light guide or other element that is to be lighted, FIGS. 1-3 illustrates a first exemplary apparatus 100 comprising a heat sink 102, a flexible printed circuit 104 and a light source 106.

As shown in FIGS. 1 & 2, the heat sink 102 may define a channel 108 having a cross-section 110. The cross-section 110 may, in turn, have a plurality of interior surfaces 112, 114, 116 that face in different directions. In one embodiment, the heat sink 102 is U-shaped and has interior surfaces 112, 114, 116 that face in three major directions 118, 120, 122. However, if the corners of the U-shaped heat sink 102 are rounded, the heat sink 102 may have interior surfaces that face in substantially more than three directions.

The flexible printed circuit 104 has a first side 124 opposite a second side 126, and is flexed to conform to at least part of the channel 108 defined by the heat sink 102. In this manner, the second side 126 of the flexible printed circuit 104 is caused to contact ones of the interior surfaces 112, 114, 116 of the channel 108 facing in at least two different directions 118, 120, 122. Preferably, however, the second side 126 of the flexible printed circuit 104 is caused to contact ones of the interior surfaces 112, 114, 116 of the channel 108 facing in at least three different directions 118, 120, 122. In this manner, the light (λ) emitted by the light source 106 will be caused to project and reflect from the channel 108 in a uniform manner.

To secure the flexible printed circuit 104 within the channel 108, the flexible printed circuit 104 may be attached to the heat sink 102 by various means, such as screws, an adhesive, or both.

The light source 106 may be mounted to the first side 124 of the flexible printed circuit 104, at least partly, and preferably wholly, within the channel 108 defined by the heat sink 102. In some embodiments, the light source 106 may comprise one or more light emitting diodes (LEDs), such as a plurality of LEDs 128, 130, 132 arranged along an axis 134 or in some other configuration (e.g., two or more rows, or a staggered or patterned configuration).

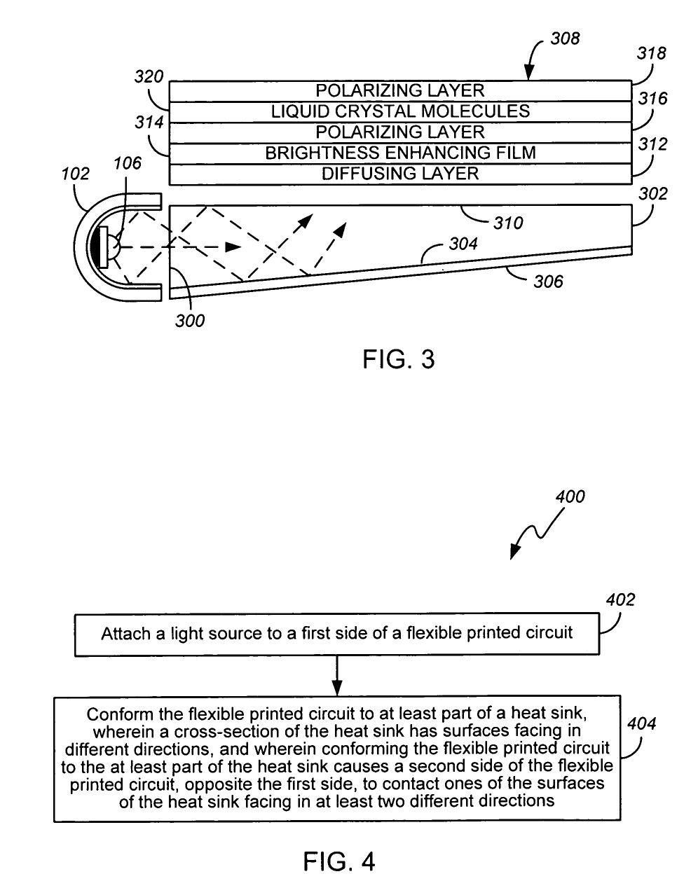

Once formed, the assembly comprised of the heat sink 102, flexible printed circuit 104 and light source 106 may be abutted to a light-receiving portion 300 (e.g., an end for a side-firing backlight, or a surface for a direct backlight) of a light guide 302. See, FIG. 3. As shown, the light guide 302 may be generally wedge-shaped, thereby enabling the light source 106 to directly illuminate an angled side 304 of the light guide 302. A reflector 306 may be abutted to the angled side 304 of the light guide 302 so as to prevent light from exiting the angled side 304; and an LCD 308 may be abutted to a light-emitting side 310 of the light guide 302.

In FIG. 3, and by way of example, the LCD 308 is shown to comprise a light diffusing layer 312, a brightness enhancing film 314, and horizontally and vertically oriented polarizing panels 316, 318 between which liquid crystal molecules 320 are trapped. Other LCDs could comprise more, fewer or different layers.

The apparatus 100 can be useful, in one respect, in that the contour of the flexible printed circuit 104 helps to direct more of the light emitted by the light source 106 toward its preferred destination, such as the light guide 302 (FIG. 3). To further ensure that the light emitted by the light source 106 is directed toward its preferred destination, the first side 124 of the flexible printed circuit 104 may be provided with a reflective surface that is formed, for example, by means of a reflective coating 136 or reflective tape that is applied to the first side 124 of the flexible printed circuit 104. See, FIG. 2.

The apparatus 100 can also be useful in that the shaped contour of the flexible printed circuit 104 helps to distribute the heat generated by the light source 106 over a greater number of surfaces 112, 114, 116 of the heat sink 102.

Although the heat sink 102 may have various compositions, it preferably has a composition with good heat-dissipating characteristics—such as a metallic composition comprising copper or aluminum.

FIG. 4 illustrates a method 400 that may be used, for example, to construct the apparatus 100 shown in FIGS. 1-3. The method 400 comprises 1) attaching 402 a light source to a first side of a flexible printed circuit, and 2) conforming 404 the flexible printed circuit to at least part of a heat sink. The heat sink has a cross-section that has surfaces facing in different directions, such that, by conforming the flexible printed circuit to the at least part of the heat sink, a second side of the flexible printed circuit, opposite the first side, is caused to contact ones of the surfaces of the heat sink that face in at least two different directions.

With respect to the apparatus 100 shown in FIGS. 1-3, the method 400 may further comprise conforming 404 the flexible printed circuit 104 to part or all of the heat sink 102 by bending the flexible printed circuit 104 toward the first side 124 of the flexible printed circuit 104, thereby causing the flexible printed circuit 104 to contact interior surfaces 112, 114, 116 of a channel 108 defined by the heat sink 102. And, if the light source 106 comprises a plurality of light emitting elements (e.g., LEDs 128, 130, 132) arranged along an axis 134, then the method 400 may comprise conforming 404 the flexible printed circuit 104 to part or all of the heat sink 102 by bending the flexible printed circuit 104, on either side of the LEDs 128, 130, 132, toward the first side 124 of the flexible printed circuit 104.

Although the steps 402, 404 of the method 400 are shown with one exemplary order, their order of the method's steps 402, 404 could be swapped (i.e., the flexible printed circuit 104 could be pre-attached to the heat sink 102 before attachment of the light source 106 to the flexible printed circuit 104).

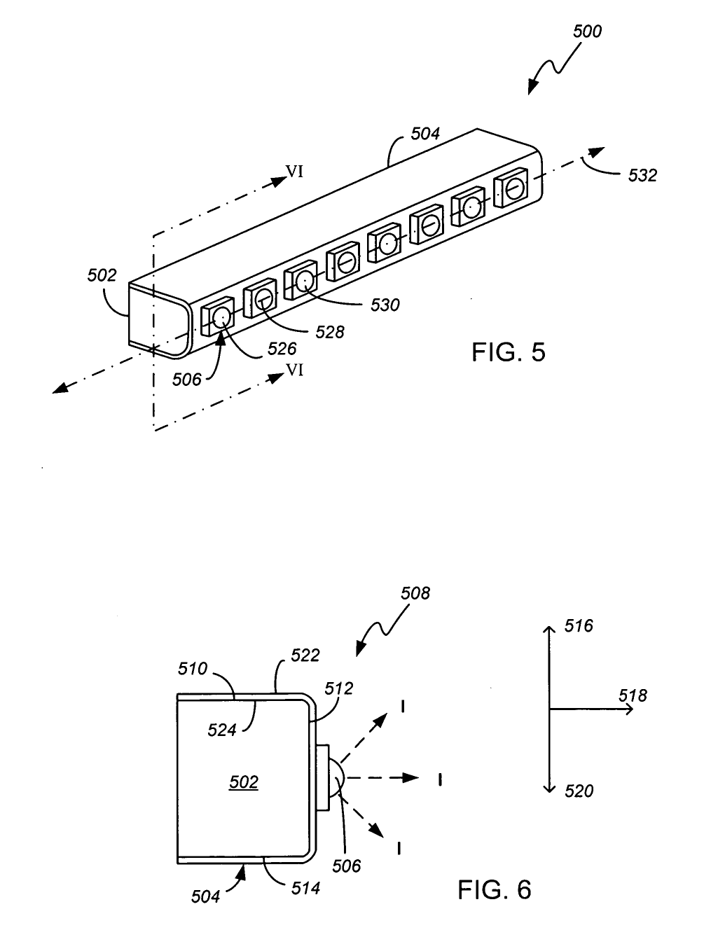

FIGS. 5, 6 & 8 illustrate a second exemplary apparatus 500 comprising a heat sink 502, a flexible printed circuit 504 and a light source 506. In contrast to the apparatus 100, the apparatus 500 may provide less (or no) redirection of the light that is emitted by the light source 506. However, the apparatus 500 may provide as good or better heat dissipation for the light source 506.

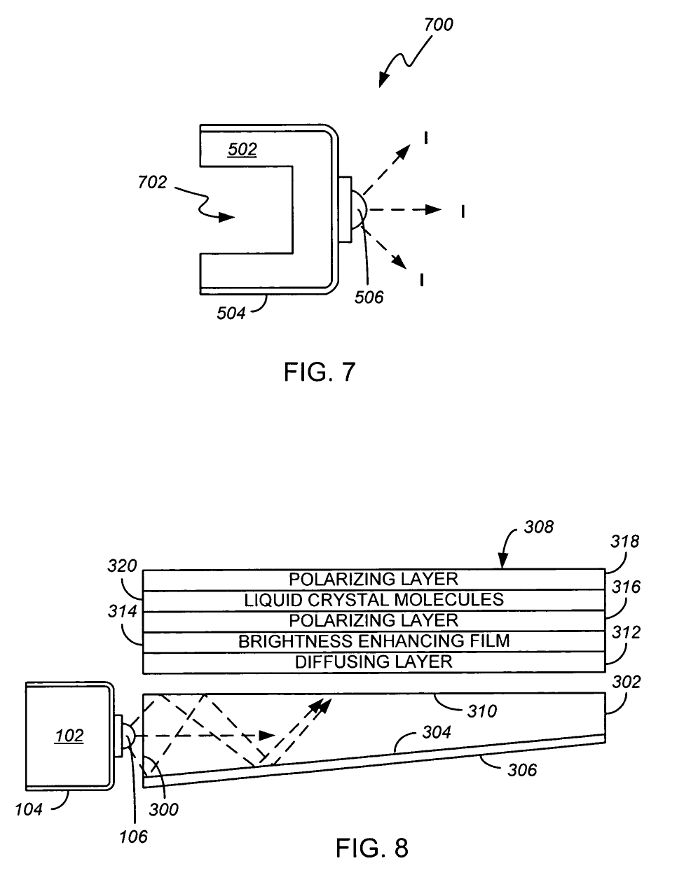

As shown in FIG. 6, the heat sink 502 may have a solid cross-section 508. Alternately, and as shown in FIG. 7, the heat sink 502 may have a cross-section 700 that defines a channel 702 on a surface other than the surface to which the light source 506 is abutted. The channel 702 may help the heat sink 502 to dissipate heat more effectively, by increasing its surface area.

Referring back to FIG. 6, the heat sink 502 may have exterior surfaces 510, 512, 514 that face in three major directions 516, 518, 520. However, if the corners of the heat sink 502 are rounded, the heat sink 502 may have exterior surfaces that face in substantially more than three directions.

The flexible printed circuit 504 has a first side 522 opposite a second side 524, and is flexed to conform to at least part of the heat sink 502. In this manner, the second side 524 of the flexible printed circuit 504 is caused to contact ones of the exterior surfaces 510, 512, 514 facing in at least two different directions 516, 518, 520. Preferably, however, the second side 524 of the flexible printed circuit 504 is caused to contact ones of the interior surfaces 510, 512, 514 facing in at least three different directions 516, 518, 520.

To secure the flexible printed circuit 504 to the heat sink 502, the flexible printed circuit 504 may be attached to the heat sink 502 by various means, such as screws, an adhesive, or both.

The light source 506 may be mounted to the first side 522 of the flexible printed circuit 504. In some embodiments, the light source 506 may comprise one or more light emitting diodes (LEDs), such as a plurality of LEDs 526, 528, 530 arranged along an axis 532 or in some other configuration (e.g., two or more rows, or a staggered or patterned configuration).

Once formed, the assembly comprised of the heat sink 502, flexible printed circuit 504 and light source 506 may be abutted to a light-receiving portion 300 (e.g., an end for a side-firing backlight, or a surface for a direct backlight) of a light guide 302. See, FIG. 8. The light guide 302, a reflector 306, and an LCD 308 may be constructed as previously described with respect to FIG. 3.

The apparatus 500 can be useful in that the shaped contour of the flexible printed circuit 504 helps to distribute the heat generated by the light source 506 over a greater number of surfaces 510, 512, 514 of the heat sink 502.

Although the heat sink 502 may have various compositions, it preferably has a composition with good heat-dissipating characteristics—such as a metallic composition comprising copper or aluminum.

Similarly to the apparatus 100 (FIGS. 1-3), the apparatus 500 (FIGS. 5, 6 & 8) may be constructed using the method 400 (FIG. 4). With respect to the apparatus 500, the method 400 may further comprise conforming 404 the flexible printed circuit 594 to part or all of the heat sink 502 by bending the flexible printed circuit 504 toward the second side 524 of the flexible printed circuit 504, thereby causing the flexible printed circuit 504 to contact exterior surfaces 510, 512, 514 of the heat sink 502. And, if the light source 506 comprises a plurality of light emitting elements (e.g., LEDs 526, 528, 530) arranged along an axis 532, then the method 400 may comprise conforming 404 the flexible printed circuit 504 to part or all of the heat sink 502 by bending the flexible printed circuit 504, on either side of the LEDs 526, 528, 530, toward the second side 524 of the flexible printed circuit 504.

Although the heat sinks 102, 502 are shown with exemplary shapes and cross-sections, it is noted that the heat sinks could assume various alternate shapes and cross-sections.

What is claimed is:

1. A method, comprising:
attaching a light source to a first side of a flexible printed circuit;
conforming the flexible printed circuit to at least part of a heat sink, wherein a cross-section of the heat sink has surfaces facing in different directions, and wherein conforming the flexible printed circuit to the at least part of the heat sink causes a second side of the flexible printed circuit, opposite the first side, to contact ones of the surfaces of the heat sink facing in at least two different directions.

2. The method of claim 1, wherein the flexible printed circuit is conformed to the at least part of the heat sink by bending the flexible printed circuit toward the second side of the flexible printed circuit.

3. The method of claim 2, wherein the surfaces of the heat sink that the flexible printed circuit is caused to contact are exterior surfaces of the heat sink.

4. The method of claim 1, wherein the light source comprises a plurality of light emitting elements, and wherein the flexible printed circuit is conformed to the at least part of the heat sink by bending the flexible printed circuit, on either side of the light emitting elements, toward the second side of the flexible printed circuit.

5. The method of claim 1, wherein the flexible printed circuit is conformed to the at least part of the heat sink by bending the flexible printed circuit toward the first side of the flexible printed circuit.

6. The method of claim 5, wherein the surfaces of the heat sink that the flexible printed circuit is caused to contact are interior surfaces of a channel defined by the heat sink.

7. The method of claim 1, wherein the light source comprises a plurality of light emitting elements, and wherein the flexible printed circuit is conformed to the at least part of the heat sink by bending the flexible printed circuit, on either side of the light emitting elements, toward the first side of the flexible printed circuit.

8. The method of claim 1, further comprising, attaching the flexible printed circuit to the heat sink using one or more screws.

9. The method of claim 1, further comprising, attaching the flexible printed circuit to the heat sink using an adhesive.

10. The method of claim 1, further comprising, abutting the light source to a light-receiving portion of a light guide.

11. Apparatus, comprising:
a heat sink that defines a channel, wherein a cross-section of the channel has a plurality of interior surfaces facing in different directions;
a flexible printed circuit having a first side opposite a second side, wherein the flexible printed circuit is flexed to conform to at least part of the channel defined by the heat sink, and wherein the second side of the flexible printed circuit contacts ones of the interior surfaces of the channel facing in at least two different directions; and
a light source, mounted to the first side of the flexible printed circuit, at least partly within the channel defined by the heat sink.

12. The apparatus of claim 11, wherein the first side of the flexible printed circuit has a reflective surface.

13. The apparatus of claim 12, wherein the reflective surface is a reflective coating applied to the flexible printed circuit.

14. The apparatus of claim 12, wherein the reflective surface is a reflective tape applied to the flexible printed circuit.

15. The apparatus of claim 11, wherein the light source is a light emitting diode (LED) light source.

16. The apparatus of claim 11, wherein the light source comprises a plurality of light emitting diodes (LEDs).

17. The apparatus of claim 11, further comprising screws that attach the flexible printed circuit to the heat sink.

18. The apparatus of claim 11, further comprising an adhesive that attaches the flexible printed circuit to the heat sink.

19. The apparatus of claim 11, wherein the heat sink is metallic.

20. The apparatus of claim 11, wherein the second side of the flexible printed circuit contacts ones of the interior surfaces of the channel facing in at least three different directions.

21. The apparatus of claim 11, wherein the channel defined by the heat sink is U-shaped.

22. The apparatus of claim 11, further comprising a light guide, the light guide having a light-receiving portion to which the light source is abutted.

23. The apparatus of claim 11, wherein the light source is mounted wholly within the channel defined by the heat sink.

24. Apparatus, comprising:
a heat sink, wherein a cross-section of the heat sink has exterior surfaces facing in different directions;
a flexible printed circuit having a first side opposite a second side, wherein the flexible printed circuit is flexed to conform to at least part of the heat sink, and wherein the second side of the flexible printed circuit contacts ones of the exterior surfaces of the heat sink facing in at least two different directions; and
a light source, mounted to the first side of the flexible printed circuit.

25. The apparatus of claim 24, wherein the light source is a light emitting diode (LED) light source.

26. The apparatus of claim 24, wherein the second side of the flexible printed circuit contacts ones of the exterior surfaces of the heat sink facing in at least three different directions.

27. The apparatus of claim 24, further comprising a light guide, the light guide having a light-receiving portion to which the light source is abutted.
